(19) United States
(12) Patent Application Publication
(10) Pub. No.: US 2004/0219938 A1
(43) Pub. Date: Nov. 4, 2004

(54) Method for providing parameters during a change of access, cellular communications system, user equipment and network element

(76) Inventors: Janne Parantainen, Helsinki (FI); Timo M. Rantalainen, Helsinki (FI); Ari Lakaniemi, Helsinki (FI); Shkumbin Hamiti, Espoo (FI); Heikki Einola, Espoo (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/476,922

(22) PCT Filed: May 5, 2001
(86) PCT No.: PCT/EP01/05028

(51) Int. Cl. H04B 7/005

(52) U.S. Cl. 455/502

(57) ABSTRACT

A method provides a first network element (22) or a user equipment of a radio access system with a current value of at least one parameter (TS) during a change of access of the user equipment (20) from another network element (21) of a radio access system to the first network element (22). The parameter is required for creating headers for packets in which data of user equipment is transmitted. In order to guarantee continuous parameter values without jumps, the current parameter values (TS) are transmitted from the other network element (21), which knows the current parameter value, to the first network element (22) or to the user equipment, and that in addition, the network element (22) or the user equipment are synchronized to the other network element (21). The network element (22) or the user equipment then corrects the received parameter value (TS) based on the synchronization.

### FIELD OF THE INVENTION

The invention relates to method for providing a user equipment or a network element of a radio access system with a current value of at least one parameter during a change of access of a user equipment from a first network element of a radio access system to a second network element of a radio access system. The invention equally relates to a cellular communications system comprising at least a first network element of a radio access system, a second network element of a radio access system and at least one user equipment suited for accessing either of the at least two network elements and for changing access from one of the network elements to another one of the network elements. The invention further relates to such a user equipment and to such network elements.

### BACKGROUND OF THE INVENTION

In cellular communications systems which transmit user data of a user equipment as payload of packets to a receiving end, a packet header has to be created for each packet and added to the packet in order to enable a correct transmission and processing of the packets and the included data in the cellular communications systems, in a core network and at the receiving end.

The packet headers are created based on different parameters. Parameters that are employed in RTP/UDP/IP (Real Time Protocol/User Datagram Protocol/Internet Protocol) packet header creation are for example real time protocol sequence numbers (SN) and real time timestamps (TS) which are generated for each packet that is to be transmitted.

The RTP/UDP/IP protocols are described for example in detail in IETF RFC1889 “RTP: A Transport Protocol for Real-Time Applications”, 1996, RFC768 “User Datagram Protocol”, 1980, and RFC760 “DOD Standard Internet Protocol”, 1980. The purpose of the RTP is to provide a function for transferring real time data, e.g. audio and video, over the internet. According to the RTP, header timestamp and sequence number fields give information that can be used in the receiving end to define the right playout time and the right order of the packets. IP and UDP provide mechanisms for transporting frames over the internet to a recipient, i.e. to an IP address port. Each generated sequence number and each generated timestamp depends on the respective preceding generated sequence number and timestamp, resulting in a continuity in the sequence of sequence numbers and timestamps.

In a cellular communication system, the location at which the parameters required for packet header creation for a specific user equipment are generated depends on the radio access system of the cellular communications system to which the user equipment is presently connected. The respective location may depend in addition on the configuration of the network element of a single radio access system to which the user equipment is presently connected, if the radio access system comprises network elements with different configurations.

Some systems, like GSM (Global System for Mobile Communications) using GERAN (Global System for Mobile communications Enhanced Data Rates for GSM evolution Radio Access Network) for radio access, support a so called header removal. That means that in the uplink direction, the necessary packet headers are created in a network element of the radio access system, e.g. a GERAN Base Station Controller (BSC). For the parameters required for header creation, the network element receives initial values, like IP port or an initial time stamp value, from the respective user equipment. Some parameters required for header creation remain constant throughout a connection. An IP address, for example, is allocated by the core network and sent to the user equipment during the call setup. For those parameters which have to change, like time stamp values and sequence numbers, the network element calculates continuously appropriate further values based on the received initial values. In such systems, the user equipment operates only based on the payload part and on what can be communicated within radio channel coding parameters. When header removal is used, protocol headers are moreover removed from the packets in downlink direction on the network side. This way it is possible on the one hand to avoid protocol overhead over the radio interface and on the other hand to use already existing channel coding schemes which have been optimized for having only voice frame as payload and no upper layer protocol headers.

Other radio access systems, like UMTS (Universal Mobile Telecommunication System) using UTRAN (UMTS Terrestrial Radio Access Network) for radio access, in contrast, do not support header removal. In these systems, the headers are not created in a network element and consequently, the changing parameters on which the header creation is based are not determined in a network element of the radio access system. Instead, these changing parameters are calculated in the user equipment itself proceeding from some initial value. The user equipment also creates the necessary headers based on the generated parameter values and on further fixed required parameter values, like an IP address. It can be moreover requested by such radio access systems that the created headers be compressed in the user equipment, e.g. by a Robust Header Compression (ROHC), in order to decrease the protocol overhead.

A user equipment can be handed over either within a system, but also between different systems, if the user equipment supports both systems. In the case that not both systems before and after handover do not support header removal, parameters required for header creation have to be generated in a different unit before and after handover. This leads to a problem regarding the continuity of the value of the parameters.

In the co-pending application PCT/EP 01/03532, which is incorporated by reference herewith, it was proposed that the unit responsible for generating the values of parameters, or alternatively a unit having knowledge of the current values, transmits these values during signaling for a change of access to the unit which is responsible to generate the parameters after handover. In particular, the values can be transmitted from a first network element, to which a user equipment is connected before a handover, to a second network element, to which this user equipment is connected after the handover. Equally, it can be transmitted from a first network element supporting header removal, to which a user equipment is connected before a handover, to the user equipment itself, in case the user equipment is connected after the handover to a second network element which does not support header removal and therefore requires the user equipment to create the packet headers. Thus, a supply of continuous values for said parameters after a change of access of a user equipment from one network element to another can be achieved.

The proposed solution has the drawback, however, that a message that is used to carry the required parameter values, e.g. a Relocation Commit message, a Handover Command or possibly a Forward SRNS Context, may have an unpredictable transfer delay. For instance in case of a handover command, the message may require retransmissions due to radio channel errors. Consequently, the time stamp value when received in the target unit should have a larger value than it actually has.

The problem is illustrated in FIG. 1 for a transmission of time stamp information during a handover from a GERAN network element constituting a source unit to a user equipment or another GERAN network element constituting a target unit.

The figure shows an upper horizontal time line indicating the time at a first GERAN network element, to which a user equipment is currently connected. The first GERAN network element supports header removal and thus creates itself the packet headers for packets used for transmitting data from the user equipment. The figure shows moreover a lower horizontal line indicating the time for a target unit. The target unit can be for example a second GERAN network element supporting header removal, to which the user equipment is to be handed over. Alternatively, the target unit can also be the user equipment, in case the user equipment is handed over to a second network element that requires packet header creation in the user equipment.

After three time stamps TS=160, 320, 480 have been generated and used for creating packet headers for three consecutive packets in the first network element, a handover of the user equipment becomes necessary and a relocation commit message is sent from the first network element to the second network element and a handover command is transmitted to the user equipment, indicated in the figure by an arrow. In order to enable the target unit to take over generating time stamps without disruption, the last generated time stamp TS=480 is included in the message to the target unit, i.e. either to the second network element or to the user equipment.

During transmission of the message and therefore of the time stamp a transfer delay may occur. In FIG. 1, an exemplary delay of 20 ms is indicated, which corresponds in case of AMR (Adaptive Multi Rate) to 160 in the RTP time stamp scale. Thus, the correct value of the time stamp should be 640 at the time of reception of the message, while the received value is 480. Therefore, the first time stamp used by the target unit will not correspond to the expected time stamp, i.e. the time stamp value can still jump with small steps. These jumps may cause problems in the receiving terminal as voice frames may be interpreted delayed and discarded or the receiver may wait for the playtime even though it could play the frame immediately. From the user perception point of view this can be annoying.

### SUMMARY OF THE INVENTION

It is an object of the invention to guarantee an improved continuation of parameter values during a change of access of a user equipment from a first network element of a radio access network to a second network element of a radio access network.

The invention comprises two different aspects. The first aspect relates to situations in which at least one parameter value of which the continuation is to be improved is needed after a change of access in a network element, while the second aspect relates to situations in which such at least one parameter value is needed after a change of access in a user equipment.

This object is reached for the first aspect of the invention with a method for providing a first network element of a radio access system with a current value of at least one parameter during a change of access of a user equipment from a second network element of a radio access system to said first network element. The at least one parameter is required on the one hand in the first network element for creating packet headers for packets used for transmitting data of said user equipment when the user equipment is connected to said first network element. On the other hand, the at least one parameter is required for creating packet headers for packets used for transmitting data of said user equipment when said user equipment is connected to said second network element. The second network element has at least knowledge of the current value of the at least one parameter when the user equipment is connected to the second network element. The current value of said at least one parameter is then transferred from the second network element to the first network element. The first and said second network element have synchronized clocks for the method of the first aspect of the invention. In addition, it is proposed that the first network element updates the received current value of the at least one parameter according to the time elapsed since said value was created, the elapsed time being determined based on the clock synchronization, before using it for creating packet headers.

For the first aspect of the invention, the object is equally reached with a cellular communications system comprising at least a first network element of a radio access system, a second network element of a radio access system and at least one user equipment suited for accessing either of the at least two network elements and for changing its access from one of the network elements to a respective other one of the network elements. The second network element comprises means for transmitting data from a user equipment connected to the second network element in packets with packet headers that were created based on the current value of at least one parameter, which value is known in the second network element. The second network element further comprises means for transmitting the current value of the at least one parameter to the first network element. The first network element comprises means for creating based on at least one parameter packet headers for packets used for transmitting data of said user equipment when said user equipment is connected to said first network element. Corresponding to the method of the first aspect of the invention, it is proposed that the first network element and the second network element have synchronized clocks. The first network element further comprises means for updating after a change of access of the user equipment from the second network element to the first network element the value of the at least one parameter received from the first network element according to the time elapsed since the received parameter value was created, which elapsed time is determined based on the clock synchronization. The means for creating packet headers of the first network element are suited to use the updated value as starting value for said at least one parameter on which the creation of headers is based.

For the first aspect of the invention, the object is moreover reached with network elements corresponding to the first and second network element of the communications network proposed for the first aspect of the invention. The proposed network element corresponding to the second network element comprises further means for transmitting in addition to the current value of the at least one parameter an indication of the time at which the packet to which the parameter was associated was transmitted.

The object is reached for the second aspect of the invention with a method for providing a user equipment with a current value of at least one parameter during a change of access of said user equipment from a first network element of a radio access system to a second network element of a radio access system. The at least one parameter is required again in said first network element for creating packet headers for packets used for transmitting data of said user equipment when the user equipment is connected to said first network element. Moreover, the at least one parameter is required in the user equipment for creating packet headers for packets used for transmitting data of said user equipment when the user equipment is connected to said second network element. The current value of the at least one parameter is transmitted by the first network element to the user equipment. For the second aspect of the invention, it is thus assumed that the user equipment and the first network element are synchronized to each other at least while the user equipment is connected to the first network element. The user equipment updates the received current value of said at least one parameter after reception according to the time elapsed since the received parameter value was created before using it for creating packet headers. The elapsed time is determined based on the synchronization.

For the second aspect of the invention, the object is equally reached with a corresponding cellular communications system. The system comprises like the system for the first aspect of the invention at least a first network element of a radio access system and a second network element of a radio access system and at least one user equipment suited for accessing either of the at least two network elements and for changing its access from one of the network elements to a respective other one of the network elements. The first network element comprises means for creating based on at least one parameter packet headers for packets used for transmitting data of said user equipment when said user equipment is connected to said first network element. The first network element further comprises means for transmitting the current value of the at least one parameter to the user equipment. The user equipment comprises means for creating based on the at least one parameter packet headers for packets used for transmitting data originating from the user equipment when the user equipment is connected to the second network element. It is proposed again that the user equipment and the first network element are synchronized at least while the user equipment is connected to the first network element. The user equipment moreover comprises means for updating, after a change of access from the first network element to the second network element, the value of the at least one parameter received from said first network element according to the time elapsed since the received parameter value was created, which elapsed time is determined based on the synchronization. The means of the user equipment for creating packet headers use the updated value as starting value for the at least one parameter, and the second network element comprises means for transmitting data from a user equipment connected to the second network element in packets with packet headers created in the user equipment.

For the second aspect of the invention, the object is moreover reached with a user equipment and a network element corresponding to the user equipment and the first network element of the communications network proposed for the second aspect of the invention. The network further comprises means for transmitting in addition to the current value of the at least one parameter an identification of a TDMA frame in which data of the user equipment was transmitted to the network element, which data is included in the packet to which the parameter was associated, or, alternatively, for transmitting in addition an indication at which time the packet to which the current value of said at least one parameter is associated was transmitted, wherein said network element and said other network element have synchronized clocks.

The invention proceeds from the idea that the influence of unpredictable transfer delays on the correctness of parameter values can be eliminated, if the units between which the parameter values are exchanged are synchronized, e.g. by having synchronized clocks or with regard to a TDMA frame structure used for transmission and reception of data, and if this synchronization is made use of for compensating for a delay in time with which the value of the at least one parameter was received. Thus, parameter values can be used continuously without disruption, and in addition, jumps in the continued value of the at least one parameter can be avoided. With such a compensation of unpredictable transfer delays of the at least one required parameter value, optimized real-time data, like IP speech in GERAN, can be provided to a user at a receiving end.

In case several current parameter values required for header creation are transmitted to a network element or to a user equipment, one or more of these parameter values might be updated in the target unit based on the synchronization. Usually, it will be parameters indicating a correct position in time of transmitted packets, in particular time stamps, that require an update.

The elapsed time compensated according to the invention can comprise not only unpredictable delays in transmission, but also processing times etc.

Preferred embodiments of the invention become apparent from the subclaims.

Preferably, the current value of said at least one parameter is transferred in any situation during signaling for a change of access of the user equipment. Then, the value can simply be added to a message transmitted anyhow between the concerned units for the change of access.

In a first situation of the first aspect of the invention, the second network element supports header removal. That means that the at least one parameter is required in the second network element from which the user equipment is handed over for creating packet headers for packets used for transmitting data of said user equipment when the user equipment is connected to said second network element. Therefore, the second network element knows the current value of the at least one parameter as required for the first aspect of the invention. An example for such a situation is given by a GERAN to GERAN handover. It could also be given by a GERAN to UTRAN handover, in case also UTRAN supports header removal.

In a second situation of the first aspect of the invention, the second network element does not support header removal. Thus, the at least one parameter is required in said user equipment for creating packet headers before a handover. The second network element then knows the current value of the parameter from the user equipment, e.g. because it is needed for header decompression in the second network element. An example for such a situation is given by a UTRAN to GERAN handover, in case it is assumed the UTRAN network element can be synchronized to the GERAN network element.

In a preferred embodiment of the first aspect of the invention, in which the local clocks of both network elements are synchronized, the second network element moreover transmits together with the current value of the at least one parameter an indication of the time of transmission of the packet to which the transmitted current value is associated. This indication is then used by the first network element to determine the elapsed time between creation and reception of the transmitted parameter value and to update the received value correctly.

In a further preferred embodiment of the first aspect of the invention, the first and the second network element are synchronized in time based on the GPS (Global Positioning System) or the NTP (Network Time Protocol).

An example for a situation for the second aspect of the invention is given by a GERAN to UTRAN handover, assuming that UTRAN does not support header removal so that the user equipment is responsible for creating packet headers and thus has to know the current value of the at least one parameter to be able to generate further values without disruption.

For the second aspect of the invention, the first network element and the user equipment are preferably synchronized in that the user equipment is synchronized to the TDMA structure used by the first network element while being connected to said first network element. I.e., reception and transmission of the user equipment are synchronized to the TDMA frame structure employed by the first network element for reception and transmission. Therefore, both have synchronized time slots and can identify TDMA frames transmitted at specified time slots. The first network element then preferably transmits together with the current value of at least one parameter an identification of a TDMA frame used for transmitting data from said user equipment to said first network element, which data is included in the packet to which the current value of the at least one parameter is associated, in order to enable the user equipment to update the received value correctly. The identification can be in particular a number associated to the TDMA frame, all TDMA frames being numbered in sequence. The user equipment then simply has to compare the received TDMA frame number with the current TDMA frame number and thus can determined from the known distance in time between two TDMA frames how much the signaling, which can be in particular a handover command, was delayed during transmission.

Alternatively, in the second aspect of the invention user equipment and first network element are synchronized by using synchronized clocks. This can be achieved again, e.g., if both clocks rely on the GPS.

In a preferred embodiment for both aspects of the invention, the transmission in RTP/UDP/IP based and the value of the at least one parameter comprises at least and the current Real Time Protocol Timestamp (RTP TS). The time stamp is then updated in the respective target unit based on the synchronization. Preferably, the current RTP Sequence Number (SN) is transmitted in addition as value of the at least one parameter.

### BRIEF DESCRIPTION OF THE FIGURES

In the following, the invention is explained in more detail with reference to drawings, of which

FIG. 1 illustrates the problem of transmission delays;

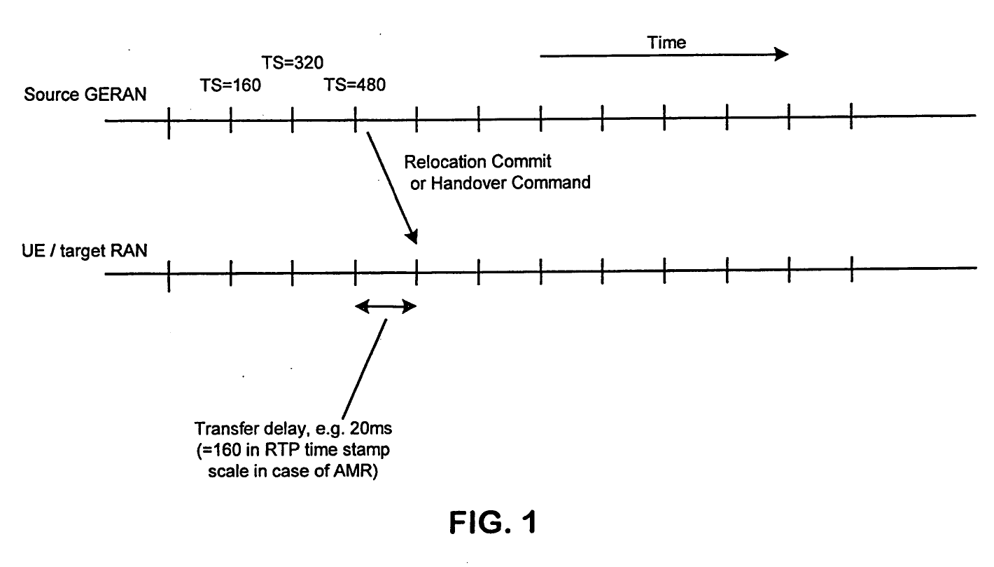

FIG. 2 illustrates an embodiment of the first aspect of the invention; and

FIG. 3 illustrates an embodiment of the second aspect of the invention.

### DETAILED DESCRIPTION OF THE INVENTION

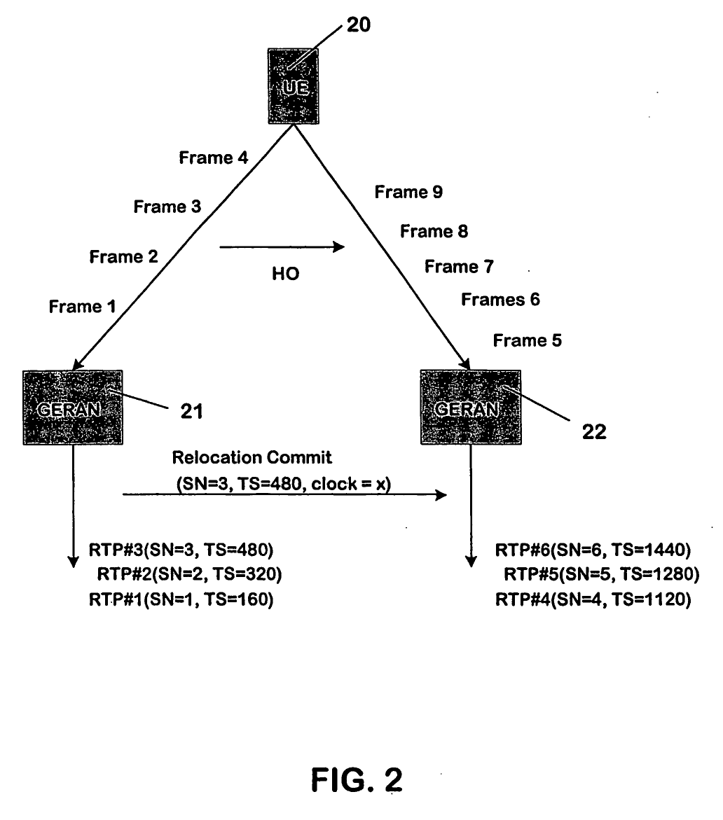

FIG. 2 illustrates a GERAN to GERAN handover of a user equipment, for which handover an embodiment of the method of the first aspect of the invention is employed.

The figure shows a first rectangle representing the user equipment 20, a second rectangle representing a first GERAN network element 21 and a third rectangle representing a second GERAN network element 22.

It is assumed that both GERAN network elements 21, 22 support header removal. Therefore, they both comprise means for generating RTP sequence numbers and RTP time stamps required for creating packet headers for packets originating from some user equipment 20 connected to the respective network element 21, 22. Moreover, it is assumed that the two GERAN network elements 21, 22 use local clocks which are synchronized in time.

The depicted user equipment 20 is first connected to the first GERAN network element 21, via which it sends voice frames 1-4. The transmission of the frames 1-4 over the air interface from the user equipment 20 to the first GERAN network element 21 is indicated by an arrow.

A header generation function of the network element 21 creates out of the received frames 1-3 RTP packets RTP#1-RTP#3 with packet headers including an RTP sequence number and an RTP time stamp. In case of AMR, the time stamp is increased by 160 for each 20 ms voice frame. In the presented example, for the first packet RTP#1, the sequence number SN is 1 and the time stamp TS is 160. For the second packet RTP#2, the sequence number SN is 2 and the time stamp TS is 320. For the third packet RTP#3, the sequence number SN is 3 and the time stamp TS is 480. The assembled packets RTP#1-RTP#3 are transmitted by the network element 21 via the core network to some receiving end, indicated in the figure again by an arrow.

Then, a handover of the user equipment 20 to the second network element 22 becomes necessary. Therefore, a Relocation Commit message, indicated in FIG. 2 by an arrow, is sent from the first network element 21 to the second network element 22 and a handover command is sent from the first network element 21 to the user equipment 20. As consequence, the access of the user equipment 20 is changed from the first network element 21 to the second network element 22, indicated in the figure by an handover arrow HO. Therefore, the user equipment 20 sends all following voice frames 5 to 9 to the second network element 22.

Some voice frames may be lost during the handover. However, this should not cause any problems as long as the serial numbers continue without disruption and as long as the time stamp values additionally always indicate a correct interval between the packets. The situation is then the same as if these frames where never transmitted. Another possible solution would be to increase the sequence number to correspond to the increased time stamp value. In this case it would be assumed that some frames have been lost during the handover. This would not cause problems in the receiver as the time stamp continues correctly. In the depicted example, frame 4 transmitted from the user equipment 20 to the first network element 21 is lost, because it arrives only after the Relocation Commit message was sent, and frames 5 and 6 transmitted from the user equipment 20 to the second network element 22 are lost during the physical layer connection establishment to the second network element 22.

In order to guarantee the required continuity in the parameter values, the first network element 21 includes in the Relocation Commit message the sequence number SN (3), the time stamp TS (480) and the sending time (x) of the last RTP packet RTP#3 sent before the Relocation Commit message is transmitted. The sending time is determined based on the local clock of the first network element 21. If the Iur interface is not used, the information could also be sent in some other message via the Iu interface, e.g. in the Forward SRNS Context message.

When the second network element 22 receives the Relocation Commit message, it determines the local clock time z at which the message is received. Since the first and the second network element 21, 22 are supposed to be time synchronized, the second network element 22 is able to determine based on the received time x and the determined local clock time the time delay z−x in the transmission of the Relocation Commit message. Based on this time delay and the received time stamp TS=480, the second network element 22 can thus determine that the updated time stamp for the first packet RTP#4 to be sent by the second network element 22 should be TS=480+(z−x), which in the example of FIG. 2 is assumed to be TS=1120.

The sequence numbers SN for the RTP packets RTP#4-6 generated in the second network element 22 are continued in a way as if the lost frames were never sent, i.e. the sequence number assigned to the packet with first frame 7 received by the second network element 22 is SN=4, which is the number following the sequence number SN=3 received from the first network element 21 for the last packet sent.

Sequence numbers and time stamps for packet headers for the packets RTP#5-6 including the following voice frames 8-9 can be determined in the second network element 22 based on the sequence number and the time stamp assigned to the first packet RTP#4. With the time stamp increased by 160 for each 20 ms voice frame, therefore for voice frame 8 a packet RTP#5 with a sequence number of SN=5 and a time stamp of TS=1280 is created, and for voice frame 9 a packet RTP#6 with a sequence number of SN=6 and a time stamp of TS=1440 is created. The assembled packets RTP#4-RTP#6 are transmitted by the second network element 22 via the core network to some receiving end, indicated in the figure as well by an arrow.

Thus, time stamp continuation without jumps is ensured during a handover in the depicted situation.

An embodiment of the method according to the second aspect of the invention will now be presented for a handover of a user equipment from a GERAN network element to an UTRAN network element.

The GERAN network element is supposed again to support header removal, while the UTRAN network element is assumed not to support header removal. As most of the information in the protocol headers is constant from frame to frame, the UTRAN network element further requires a connected user equipment to employ header compression for transmitting packets over the radio interface in order to decrease the protocol overhead. Thus, during a handover, the RTP end point changes from the GERAN network element to the user equipment and therefore, the current time stamp value must be communicated from the GERAN network element to the terminal. A handover command can be used to carry this information from the GERAN network element to the user equipment.

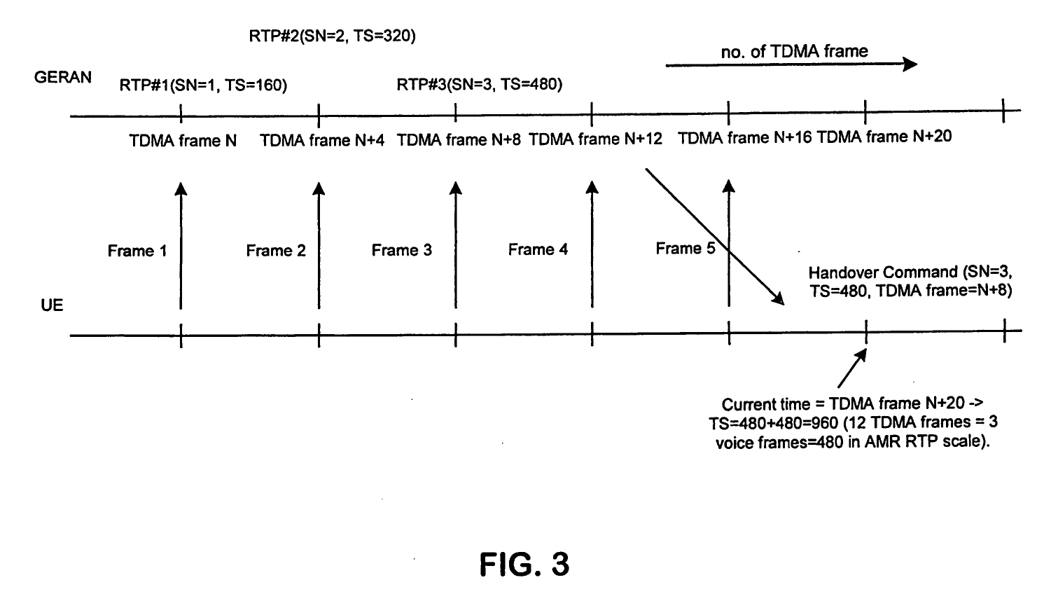

FIG. 3 illustrates the passing on of a time stamp according to the second aspect of the invention from the GERAN network element to the user equipment during handover.

In the figure, an upper horizontal time line indicates the time on the GERAN side and a lower horizontal time line indicates the time at the user equipment.

Small vertical lines on both horizontal lines indicate the beginning of selected TDMA frames N, N+4, N+8 etc., which are located at identical positions in time for both, the GERAN network element and the user equipment, due to a synchronization between the two units for TDMA frame transmissions.

Before the handover, the user equipment sends voice frames 1-5 to the GERAN network element in TDMA frames, indicated by arrows from the GERAN time line to the time line associated to the user equipment. Two voice frames are sent in 8 TDMA frames, because of interleaving in order to mitigate the fades in the radio channel. Therefore, if the first voice frame 1 is transmitted in the TDMA frames beginning with TDMA frame N, the following voice frame 2 is transmitted in TDMA frames beginning with TDMA frame N+4, the next voice frame 3 in TDMA frames beginning with TDMA frame N+8, and so forth.

Since the GERAN network element supports header removal, it has to generate packet headers for the packets RTP#1-3 in which the received voice frames 1-3 are to be transmitted. The packet headers include again the respective sequence number SN and the respective time stamp TS. Taking AMR again as a basis, the time stamp value is increased by 160 for each 20 ms voice frame. Other codecs use a different increase of succeeding time stamp values. As in the first embodiment, in the depicted example, the first packet RTP#1 is assigned the sequence number SN=1 and the time stamp TS=160, the second packet RTP#1 is assigned the sequence number SN=2 and the time stamp TS=320, and the third packet RTP#1 is assigned the sequence number SN=3 and the time stamp TS=480.

After the third RTP packet RTP#3 was assembled and transmitted by the GERAN network element, a handover of the user equipment to an UTRAN network element becomes necessary. The GERAN network element therefore sends a handover command to the user equipment, indicated in the figure by an arrow from the GERAN time line to the time line associated to the user equipment. This handover command contains in addition the last used sequence number SN=3, the last used time stamp TS=480, and the TDMA frame number of the first TDMA frame with which the voice frame of the last packet RTP#3 was transmitted from user equipment to GERAN network element, i.e. TDMA frame=N+8.

Based on the current TDMA frame number and the received information, the user equipment initialize the time stamp value and ensures that it does not jump during the handover.

In the present example, the user equipment knows that the next TDMA frame that would have been employed after reception of the handover command is TDMA frame N+20. The time difference to the information received in the handover command is therefore (N+20)−(N+8)=12 TDMA frames. 12 TDMA frames correspond to 3 voice frames of 160 each in AMR RTP scale. Therefore the time stamp of TS=480 received in the handover command has to be increased by 480=3*160 for creating the packet header for the next voice frame. That is, the first packet header created by the user equipment for transmission to the UTRAN network element to which the user equipment was handed over will contain a time stamp of 960 and a sequence number of 4, which follows the sequence number included in the handover command.

Thus, in order to solve the problem of unpredictable transfer delays of a handover command, the user equipment and the GERAN network element use transmitted TDMA frames as a common clock, which is possible because of the synchronization between user equipment and the GERAN network element for transmitting these TDMA frames.

Both embodiments have therefore in common that an indication of the time at which the last packet was transmitted by the network element to which the user equipment was connected before handover is transmitted. This indication is transmitted together with the values of parameters required for header creation to the unit in which the parameters are required after a handover for packet header creation. Together with the synchronization of the respective two units, the target unit thus is able to determine the delay of the message with the values of the required parameters and to compensate for the determined delay by adapting at least one of the received values accordingly.

A synchronization of units can also be made use of in any other suitable way in order to determine the delay of a signaling message and thus a correction of a received value of a required parameter.

1. A method for providing a first network element (22) of a radio access system with a current value of at least one parameter (TS) during a change of access of a user equipment (20) from a second network element (21) of a radio access system to said first network element (22), in which at least one parameter (TS) is required in said first network element (22) for creating packet headers for packets (RTP#4-6) used for transmitting data (frame 7-9) of said user equipment (20) when the user equipment (20) is connected to said first network element (22), and in which at least one parameter (TS) is required for creating packet headers for packets (RTP#1-3) used for transmitting data (frame 1-3) of said user equipment (20) when said user equipment (20) is connected to said second network element (21), said second network element (21) knowing the current value of said at least one parameter (TS) when said user equipment (20) is connected to said second network element (21), wherein the current value of said at least one parameter (TS) is transferred from said second network element (21) to said first network element (22), wherein said first and said second network element (22,21) have synchronized clocks, and wherein the first network element (22) updates the received current value of at least one parameter (TS) according to the time elapsed since said value was created, the elapsed time being determined based on the clock synchronization, before using it for creating packet headers.

2. A method according to claim 1, wherein said at least one parameter (TS) is required in said second network element (21) for creating packet headers for packets (RTP#1-3) used for transmitting data (frame 1-3) of said user equipment (20) when the user equipment (20) is connected to said second network element (21).

3. A method according to claim 1, wherein said at least one parameter is required in said user equipment for creating packet headers for packets used for transmitting data of said user equipment when said user equipment is connected to said second network element.

4. A method according to claim 1, wherein the current value of said at least one parameter (TS) is transferred from said second network element (21) to said first network element (22) during signaling for a change of access.

5. A method according to claim 1, wherein the second network element (21) transmits together with the current value of the at least one parameter (TS) an indication (clock) of the time of transmission of the packet (RTP#3) to which the transmitted current value of the at least one parameter (TS) is associated in order to enable the first network element (22) to update the received value correctly.

6. A method according to claim 1, wherein said first network element (22) and said second network element (21) are time synchronized based on the Global Positioning System (GPS) or on the Network Time Protocol (NTP).

7. A method for providing a user equipment with a current value of at least one parameter (TS) during a change of access of said user equipment from a first network element of a radio access system to a second network element of a radio access system, in which at least one parameter (TS) is required in said first network element for creating packet headers for packets (RTP#1-3) used for transmitting data (frame 1-3) of said user equipment when the user equipment is connected to said first network element, and in which at least one parameter (TS) is required in said user equipment for creating packet headers for packets used for transmitting data of said user equipment when the user equipment is connected to said second network element, wherein the current value of said at least one parameter (TS) is transmitted by said first network element to said user equipment, and wherein said user equipment and said first network element are synchronized to each other at least while said user equipment is connected to said first network element, the user equipment updating the received current value of at least one parameter (TS) after reception according to the time elapsed since said value was created, the elapsed time being determined based on said synchronization, before using it for creating packet headers.

8. A method according to claim 7, wherein the current value of said at least one parameter (TS) is transmitted by said first network element to said user equipment during signaling for the change of access.

9. A method according to claim 7, wherein said user equipment is synchronized to a TDMA frame structure employed by said first network element while being connected to said first network element.

10. A method according to claim 9, wherein said first network element transmits together with the current value of at least one parameter (TS) an identification (TDMA frame=N+8) of a TDMA frame used for transmitting data between said user equipment and said first network element, which data is included in the packet to which the current value of the at least one parameter (TS) is associated, in order to enable the user equipment to update the received value correctly.

11. A method according to claim 7, wherein said user equipment and said first network element are synchronized to each other by having synchronized clocks.

12. A method according to claim 7, wherein the value of the at least one parameter comprises at least the current Real Time Protocol Timestamp (RTP TS).

13. A cellular communications system comprising at least a first network element (22) of a radio access system, a second network element (21) of a radio access system and at least one user equipment (20) suited for accessing either of the at least two network elements (22,21) and for changing its access from one of the network elements (22) to a respective other one of the network elements (21), wherein said second network element (21) comprises means for transmitting data (frame 1-3) from a user equipment (20) connected to said second network element (21) in packets (RTP#1-3) with packet headers that were created based on the current value of at least one parameter (TS), which value is known in the second network element (21), and for transmitting said value of said at least one parameter (TS) to said first network element (22), and wherein said first network element (22) comprises means for creating based on at least one parameter (TS) packet headers for packets (RTP#4-6) used for transmitting data (frame 7-9) of said user equipment (20) when said user equipment (20) is connected to said first network element (22), wherein said first network element (22) and said second network element (21) have synchronized clocks, and wherein said first network element (22) comprises means for updating after a change of access from the second network element (21) to the first network element (22) the value of at least one parameter (TS) received from said second network element (21) according to the time elapsed since said value was created, the elapsed time being determined based on the clock synchronization, the means for creating packet headers of the first network element (22) using the updated value as a starting value for said at least one parameter (TS).

14. A cellular communications system according to claim 13, wherein said second network element (21) comprises means for transmitting said value of said at least one parameter (TS) to said first network element (22) during signaling for a change of access of said user equipment (20) to said first network element (22).

15. A cellular communications system comprising at least a first network element of a radio access system, a second network element of a radio access system and at least one user equipment suited for accessing either of the at least two network elements and for changing its access from one of the network elements to a respective other one of the network elements, wherein said first network element comprises means for creating based on at least one parameter (TS) packet headers for packets (RTP#1-3) used for transmitting data (frame 1-3) of said user equipment when said user equipment is connected to said first network element and means for transmitting the current value of said at least one parameter (TS) to said user equipment, wherein said user equipment comprises means for creating based on said at least one parameter (TS) packet headers for packets used for transmitting data of said user equipment when the user equipment is connected to said second network element, wherein said user equipment and said first network element are synchronized to each other at least while said user equipment is connected to said first network element, wherein said user equipment comprises means for updating after a change of access from the first network element to the second network element the value of at least one parameter (TS) received from said first network element according to the time elapsed since said value was created, the elapsed time being determined based on said synchronization, wherein the means of said user equipment for creating packet headers use the updated value as a starting value for said at least one parameter (TS), and wherein said second network element comprises means for transmitting data from a user equipment connected to said second network element in packets with packet headers created in said user equipment.

16. A cellular communications system according to claim 15, wherein said first network element comprises means for transmitting the current value of said at least one parameter (TS) to said user equipment during signaling for a change of access of said user equipment to said second network element.

17. A cellular communications system according to claim 15, wherein said user equipment and said is synchronized to a TDMA frame structure used by said first network element while being connected to said first network element.

18. A cellular communications system according to claim 15, wherein said user equipment and said first network element have synchronized clocks.

19. A user equipment designed to be able to access at least two network elements of one or more radio access systems and comprising means for creating based on at least one parameter packet headers for packets used for transmitting data of said user equipment when said user equipment is connected to a network element which requires headers to be created in said user equipment, and means for receiving a starting value for said at least one parameter, wherein the user equipment receives said starting value from a network element which does not require headers to be created in said user equipment, and to which it is connected before changing access to a network element which requires headers to be created in said user equipment, wherein the user equipment and first network element which does not require headers to be created in said user equipment are synchronized to each other at least while the user equipment is connected to said network element, and wherein said user equipment comprises means for updating the received starting value of at least one parameter according to the time elapsed since said starting value was created, the elapsed time being determined based on said synchronization, said user equipment using the starting value only after the update for said at least one parameter.

20. A user equipment according to claim 19, comprising means for receiving a starting value for said at least one parameter during signaling for a change of access of said user equipment from a network element which does not require headers to be created in said user equipment to a network element which requires headers to be created in said user equipment.

21. A user equipment according to claim 19, which user equipment is synchronized before a change of access to a TDMA frame structure employed by said network element to which it is connected before changing access.

22. A user equipment according to claim 19, which user equipment has a clock synchronized with the clock of said network element which does not require headers to be created in said user equipment.

23. A network element (21) for a radio access system of a cellular communications system, which network element (21) comprises means for transmitting data (frame 1-3) from a user equipment (20) connected to said network element in packets (RTP#1-3) with packet headers which were created based on a value of at least one parameter (TS), and means for transmitting the current value of said at least one parameter (TS) to another network element (22) together with an indication (clock) at which time the packet (RTP#3) to which the current value of said at least one parameter (TS) is associated was transmitted, wherein said network element (21) and said other network element (22) have synchronized clocks.

24. A network element (21) according to claim 23, wherein said means for transmitting the current value of said at least one parameter (TS) to another network element (22) transmit said value during signaling for a change of access of said user equipment (20) to said other network element (22).

25. A network element for a radio access system of a cellular communications system, which network element comprises means for transmitting data (frame 1-3) from a user equipment connected to said network element in packets (RTP#1-3) with packet headers which were created based on a value of at least one parameter (TS), and means for transmitting the current value of said at least one parameter (TS) to a user equipment together with an identification (TDMA frame=N+8) of a TDMA frame (frame 3) in which data of the user equipment was transmitted to said network element, which data is included in the packet (RTP#3) to which the current value of said at least one parameter (TS) is associated, wherein said user equipment is synchronized to a TDMA frame structure employed by said network element before changing access to said other network element.

26. A network element according to claim 25, wherein said means for transmitting the current value of said at least one parameter (TS) to a user equipment transmit said value during signaling for a change of access of said user equipment to another network element.

27. A network element for a radio access system of a cellular communications system, which network element comprises means for transmitting data from a user equipment connected to said network element in packets with packet headers which were created based on a value of at least one parameter, and means for transmitting the current value of said at least one parameter to a user equipment together with an indication at which time the packet to which the current value of said at least one parameter is associated was transmitted, wherein said network element and said user equipment have synchronized clocks.

28. A network element according to claim 27, wherein said means for transmitting the current value of said at least one parameter to a user equipment transmit said value during signaling for a change of access of said user equipment to another network element.

29. A network element (22) for a radio access system of a cellular communications system, which network element (22) comprises means for generating at least one parameter (TS) required for creating packet headers for packets (RTP#4-6) that are to transmit data (frame 7-9) from a user equipment (20) accessing said network element (22), and means for receiving a starting value for said at least one parameter (TS) from said other network element (21), wherein said network element (22) and said other network element (21) have synchronized clocks, and wherein said network element (22) comprises means for updating the received starting value of at least one parameter (TS) according to the time elapsed since said starting value was created, the elapsed time being determined based on the clock synchronization, the network element (22) using said starting value only after the update for said at least one parameter (TS).

30. A network element (21) according to claim 29, wherein said means for receiving a starting value for said at least one parameter (TS) from said other network element (21) receive said starting value during signaling for a change of access of a user equipment (20) to said network element (22) from another network element (21).
